(19) United States
(12) Patent Application Publication
(10) Pub. No.: US 2004/0080420 A1
(43) Pub. Date: Apr. 29, 2004

(54) Child security alarm bracelet

(76) Inventor: Marjorie Ellen Roberts, Columbus, IN (US)

Correspondence Address: MARJORIE ROBERTS, 5621 BLACK OAK DRIVE, COLUMBUS, IN, 47201, US

(21) Appl. No.: 10/281,941

(22) Filed: Oct. 28, 2002

(51) Int. Cl. G08B 23/00

(52) U.S. Cl. 340/573.4; 340/539.11

(57) ABSTRACT

The invention relates to a set of radio controlled devices that are compromised of a “pager style” receiver unit and a transmitter bracelet. Bracelets are intended to accommodate parents in the safety of their children in crowded malls, sporting events and other public settings.

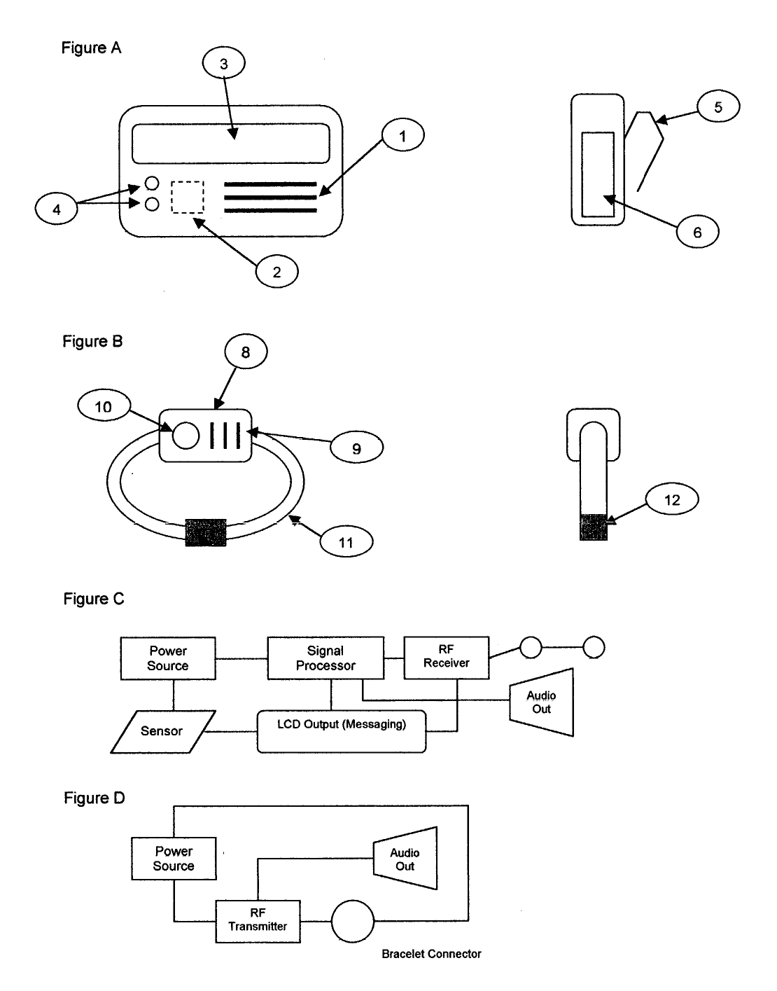

The need for these bracelets is at a crisis peak in our country as many children are being abducted, while by-standers are unaware of any wrongdoing. The pager unit and the bracelet act interdependently upon a radio signal transmission between the set. An adult wears the main pager unit and the safety bracelet is to be worn by their child. Sets will be packaged to accommodate families of all sizes. The operation of the bracelet is set to a determined distance, if the child is moved from the set parameter an alarm will sound on both the adult's and child's unit. Additionally, an alarm will sound if the bracelet is moved or tampered with in any way. When the alarm is sounded it will thereby alert the parent and others surrounding the child to the danger imposed, and giving an instant warning to suppress any threat.

The “Child Security Alarm Bracelet” is a secure means by which the parent/guardian will be able to add to the safety and well being of their child. This device will provide security in everyday situations of transportation, recreation, shopping, and other daily events that parents would attend with their children.

Our country and our world are being threatened in many ways. Parents need a secure means to assist them in monitoring their child, even if it is to make sure a child doesn't wander away from their secure surrounding to a potentially dangerous setting of a lake or swimming pool. The “Child Security Bracelet” will become a tool that parents, babysitters, grandparents and other caregivers will be able to use to help in monitoring children. Those who would want to do harm to a child have been able to slip away unnoticed into a crowd, but with a bracelet that will sound an alarm, a potential abductor will not be able to flee undetected. The “Child Security Alarm Bracelet” with a “pager style” transmitter body and a bracelet that will receive the radio signal will accomplish this.

A proximity sensor that will signal an alarm to sound if a child is moved out of the set distance will code the security bracelet. An alarm will sound if the child is moved from a set parameter notifying the caregiver and those within the immediate range that the child could be in a potentially dangerous situation. The specifications for this interdependent set of transmitter and bracelet are as follows:

The main transmitter body will include an audio speaker that will be used for the alarm mode and activated by the proximity sensor in the receiver bracelet. (The proximity sensor will be enclosed inside a bracelet to be worn by the child.) There will be a LCD screen to confirm the distance to which the parent/guardian sets the bracelet. The unit will be programmed utilizing a set a numerical buttons for data entry as to the set distance ranging between 10 and 500 feet. A 9-volt battery will power the unit. The unit will be made out of materials similar to that of a pager with an added belt clip for ease of use. It will also accommodate the sensor that will detect a signal from the child bracelet.

The child receiver bracelet will be compromised of a transmitter unit, which will generate a proximity signal that will be detected by the main base noting the distance the child is from their caregiver. The bracelet will include an audio speaker that will sound if the child is removed or if there is any tampering with the device. It too will include a battery to power the speaker and proximity sensor. The device will be made out of a non-toxic, pliable plastic that will allow for freedom of movement, yet be able to fasten securely in place.

### CROSS-REFRENCE TO RELATED APPLICATIONS

“Not Applicable”

### FEDERALLY SPONSORED RESEARCH OR DEVELOPMENT

“Not Applicable”

### SEQUENCE LISTING

“Not Applicable”

### BACKGROUND OF THE INVENTION

The invention generally relates to the utility design of an alarm system to be used by parents/guardians in the safety of their young children. It is in the field of electronic monitoring of a child in relation to the distance a child is from their caregiver.

### BRIEF SUMMARY OF THE INVENTION

In summary, the invention relates to a radio frequency signal being sent between two or more corresponding units. The base unit includes a receiver for the radio signal; the second unit includes the transmitter that sends the signal impulse. The two units work interdependently and have the capability to secure additional units to the base.

### BRIEF DESCRIPTION OF THE SEVERAL VIEWS OF THE DRAWING

Figure A illustrates the utility design of the “pager-style” receiver base unit.

Figure B illustrates the utility design of the transmitter bracelet.

Figure C illustrates the basic electronic schematic of the receiver base unit.

Figure D illustrates the basic electronic schematic of the transmitter bracelet.

### DETAILED DESCRIPTION OF DRAWINGS OF THE INVENTION

The current invention is represented by Figure A to illustrate the main components of the base unit. Figure B illustrates the main components of the transmitter unit. In Figure C, the diagram summarizes the basic electronic schematic of the base unit, and in Figure D, the diagram shows the basic electronic schematic of the safety bracelet.

Figure A illustrates the main transmitter body, to be the size of a standard pager. Item 1, is comprised of an audio speaker that is used for the alarm mode (and is activated by the proximity sensor). Item 2, is the proximity sensor. Item 3, shows the main LCD screen, allowing the user to obtain information for general system operation, as well as alarm sequence messaging. Item 4 allows for programming of the unit utilizing a set of buttons. Item 5 allows for a belt attachment clip, which can be removed if so desired. Item 6 illustrates the battery cover, which houses the main power source (a 9-volt battery). Also listed is the corresponding numbers to their illustrated components.

Figure B Identifies the Child Security Bracelet comprised of the following components: Item 8, consists of the safety bracelet transmitter unit, which generates a proximity signal to be detected by the main receiver unit. Item 9, identifies the audio speaker, which is activated once the child security bracelet exits the set proximity setting programmed on the main transmitter. Item 10, consists of the activation button, which sets the bracelet to active mode. Item 11 illustrates a onesize type bracelet attachment device. Item 12 shows a clasp that closes the electrical circuit loop, needed for alarm activation. If the bracelet is tampered with or disengaged from the child (Item 8) is activated and the signal is proceed within the main unit. This signal activates the alarm, while displaying the distance setting.

(Alarm bracelets will come with a warning that they are not infallible, due to human error in settings, etc. A sounding alarm should not be taken with immediate action, but with reasonable measures, similar to security alarms attached to merchandise, that may set off, not due to shoplifting, but human error in failing to deactivate the sensors attached to the merchandise.)

Optionally the transmitter/receiver set will be made to receive signals from one bracelet back to the base unit with the option of adding additional units to the main base.

From the beginning it will be seen that this invention is one that will be well received into our present culture and environment. There will be certain advantages of this product. To meet an average family income with a modest priced system to aid in protecting their child. There are also other inherent advantages to this design, which are obvious in their appearance.

It will be further acknowledged that certain features of this design will be referenced to with utility purposes and will not necessarily be referenced to other parts, which is within the claims presented.

There are various possible alterations that could be made to the invention without compromising the original intent and it is also understood that all drawing will be seen for their illustrative purposes and not in any limiting fashion.

1. A transmitter/receiver set comprising of:
1. A base unit similar in size to that of a pager will receive a radio frequency signal and will be capable of receiving up to five signals;
2. At least one safety bracelet capable of transmitting the signal via radio frequency to the base unit;
3. Alarm activation parameters within the base unit to allow for setting various distances;
4. Alarm activation to prevent removal or tampering to system;
1. It is the object of this invention to have a main base unit to be worn by the caregiver that will receive up to five radio signals.
2. It is another object of this invention to be capable to have at least one receiver bracelet to receive the signal from the main unit.
3. It is another object of this invention to have the capability to be set within programmable boundaries from 10 feet to 500 feet.
4. It is another object of this invention to provide an alarm to sound when a child is moved away from a set parameter of their caregiver.
